(19) United States
(12) Patent Application Publication
(10) Pub. No.: US 2018/0086378 A1
(43) Pub. Date: Mar. 29, 2018

(54) POSITION DETECTION SYSTEM FOR A RETRACTABLE STEERING COLUMN

(71) Applicant: STEERING SOLUTIONS IP HOLDING CORPORATION, Saginaw, MI (US)

(72) Inventors: Cody L. Bell, Hemlock, MI (US); Derek M. Warnemuende, Frankenmuth, MI (US); Michael J. Srda, Clio, MI (US)

(21) Appl. No.: 15/277,656

(22) Filed: Sep. 27, 2016

(51) Int. Cl. B62D 15/02; B62D 1/183; B62D 1/185; B62D 1/181; G01D 5/14

(52) U.S. Cl. CPC B62D 15/02; B62D 1/183; G01D 5/14; B62D 1/181; B62D 1/185

(57) ABSTRACT

A retractable steering column assembly for a selectively autonomous vehicle includes a lower jacket. Also included is a column housing moveable between an extended position and a retracted position. Further included is a plurality of teeth fixed to a surface of the lower jacket. Yet further included is a pinion gear in meshed engagement with the plurality of teeth. Also included is a potentiometer having an input shaft operatively coupled to the gear, the potentiometer converting motion of the gear into an electrical signal that corresponds to a position of the column housing.

### BACKGROUND

Vehicle steering wheels are typically used to steer a vehicle. When a vehicle is equipped with an autonomous driving assist steering (“ADAS”) system, the steering wheel may not be needed during certain driving modes. As such, the steering column that the steering wheel is attached to may be retracted to provide additional space for driver comfort, for example.

Retraction and extension of the steering column benefits from a column positioning system that determines and tracks the translational movement of the steering column. However, when the steering column is manually translated from its retracted position by the driver, it is possible for the steering column to be returned to its pre-retracted position with a significant offset by the ADAS system. When this occurs, the axial position of the steering column is undesirably no longer known by the column positioning system.

### SUMMARY OF THE INVENTION

In one embodiment of the disclosure, a position detection system for a retractable steering column assembly includes a track having a plurality of teeth extending therealong, the track operatively coupled to a stationary portion of the retractable steering column assembly. Also included is a gear in meshed engagement with the plurality of teeth of the track and moveable therealong. Further included is an electrical measuring component operatively coupled to the gear to convert motion of the gear into an electrical signal that corresponds to a position of a retractable portion of the retractable steering column assembly, the retractable portion translatable between an extended position and a retracted position, the electrical measuring component operatively coupled to the retractable portion.

In another embodiment of the disclosure, a position detection system for a retractable steering column assembly includes a track having a planar surface of a stationary portion of the retractable steering column assembly. Also included is a wheel in contact with the track and moveable therealong. Further included is an electrical measuring component operatively coupled to the wheel to convert motion of the wheel into an electrical signal that corresponds to a position of a retractable portion of the retractable steering column assembly, the retractable portion translatable between an extended position and a retracted position, the electrical measuring component operatively coupled to the retractable portion.

In yet another embodiment of the disclosure, a retractable steering column assembly for a selectively autonomous vehicle includes a lower jacket. Also included is a column housing moveable between an extended position and a retracted position. Further included is a plurality of teeth fixed to a surface of the lower jacket. Yet further included is a pinion gear in meshed engagement with the plurality of teeth. Also included is a potentiometer having an input shaft operatively coupled to the gear, the potentiometer converting motion of the gear into an electrical signal that corresponds to a position of the column housing.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a side, elevation view of a retractable steering column assembly having a position detection system;

FIG. 2 is a perspective view of the position detection system; and

FIG. 3 is an elevation view of the position detection system.

### DETAILED DESCRIPTION

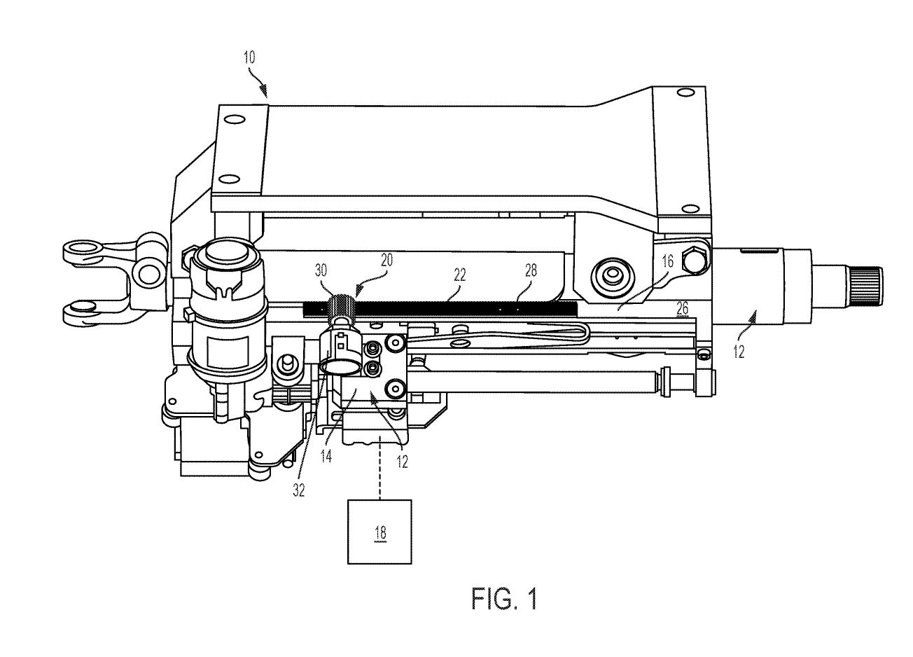

Referring now to the Figures, where embodiments will be described, without limiting same, FIG. 1 illustrates a portion of an embodiment of a retractable steering column assembly 10. The steering column assembly 10 is part of an autonomous driving assisted steering (“ADAS”) system equipped vehicle in some embodiments. The steering column assembly 10 generally includes a steering column shaft and a steering input device, such as steering wheel (not shown), coupled thereto.

The steering column assembly 10 is movable between an extended position and a retracted position. In the extended position, a driver can easily reach the steering wheel and provide directional control of the vehicle in a non-autonomous driving mode. In the retracted position, portions of the steering column assembly 10, such as the steering wheel, and an upper jacket that the steering wheel is coupled to, are disposed away from the driver toward or into an instrument panel, thereby providing increased space for the driver during autonomous driving. In particular, one or more retractable portions 12 of the steering column assembly are translatable between the extended position and the retracted position. The displacement of the retractable portion(s) 12 into the retracted position creates additional cabin space for the driver's comfort and convenience to perform non-driving activities including, but not limited to, reading, working, entertaining, eating, texting, etc., while the vehicle is in an autonomous or semi-autonomous driving mode.

The retractable portion 12 comprises the upper jacket that is in telescoping engagement with a stationary portion 16 of the steering column assembly 10. The stationary portion 16 may also be referred to herein as a lower jacket of the steering column assembly 10. The retractable portion(s) 12 of the steering column assembly 10 are extended and retracted, relative to the stationary portion 16, thereby allowing the relative movement between the retractable portion(s) 12 and the stationary portion 16 to accurately indicate the position of the retractable portion 12.

The ADAS system is configured to receive and process data associated with the position (e.g., extended or retracted) of the retractable portion 12 of the steering column assembly 10. This allows the ADAS system to electromechanically move the retractable portion 12 to desired positions when transitioning between positions of the steering column assembly 10. In particular, the ADAS system includes at least one processor and/or controller 18, or the like, that is in operative communication with the retractable portion 12. The controller 18 controls translation of the retractable portion 12 between the extended position and the retracted position.

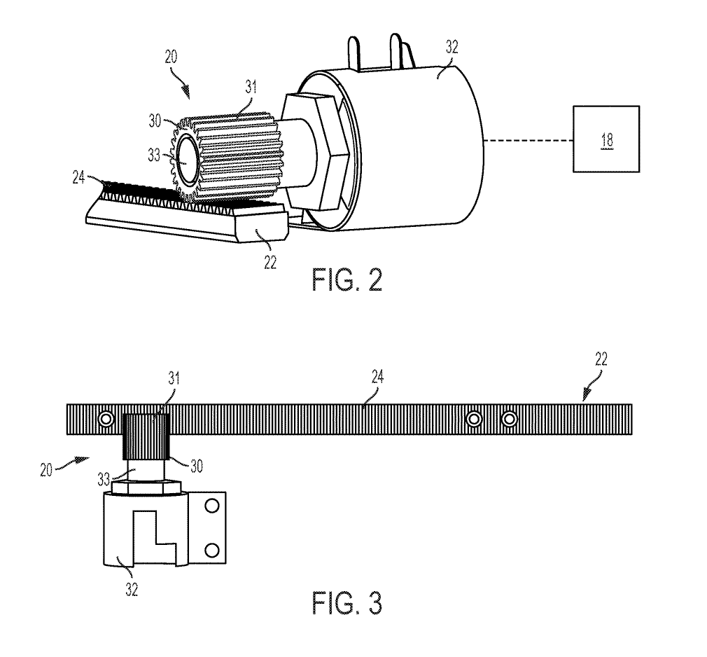

Referring now to FIGS. 2 and 3, with continued reference to FIG. 1, a position detection system 20 for the retractable steering column assembly 10 is illustrated. The position detection system 20 provides data to the ADAS system to allow the system to continuously “know” the absolute position of the retractable portion 12 of the steering column assembly 10, thereby ensuring proper subsequent automated translation of the assembly.

The position detection system 20 includes a track 22 having a plurality of teeth 24 extending therealong. In some embodiments, the track 22 is a component that is separate from the stationary portion 16 to which the track 22 is operatively coupled to. In such embodiments, the track 22 is operatively coupled to an outer surface 26 of the stationary portion 16 with mechanical fasteners 28 or via welding, for example. Alternatively, the plurality of teeth 24 of the track 22 may be integrally formed into the outer surface 26 of the stationary portion 16.

The plurality of teeth 24 of the track 22 are sized and spaced to facilitate a meshed engagement with teeth 31 of a gear 30. The gear 30 is a pinion gear that is operatively coupled to an input shaft 33 of an electrical measurement component 32 that converts rotational motion of the gear 30 into an electrical signal that corresponds to a position of the retractable portion 12 of the retractable steering column assembly 10. Each tooth 24 of the track 22 traversed by the gear 30 results in an electrical signal that positively indicates a position of the retractable portion 12. In some embodiments, the electrical measurement component 32 is a potentiometer. This is based on the electrical measurement component 32 being operatively, and fixedly, coupled to the retractable portion 12. In the illustrated embodiment, the electrical measurement component 32 is indirectly coupled to one or more stationary portions of the steering column assembly 10. Specifically, the electrical measuring device 32 is operatively coupled to the retractable portion 12 with a split nut housing 14 for retaining a split nut in the illustrated embodiment.

The electrical measurement component 32 is in operative communication, which may be wired or wireless, with the controller 18 of the ADAS system to provide the positional data to the system. As described above, the positional data allows the ADAS system to continuously and positively identify the position of the retractable portion 12 along an entire range of translation of the retractable portion 12. Advantageously, there are no positional “dead zones” along the range of translation. Additionally, the position detection system 20 is sensitive to manual manipulation of the retractable portion 12, thereby tracking movement due to manual translation.

As an alternative to the meshed toothed engagement described above, in some embodiments, the track 22 is a solid surface of the outer surface 26 of the stationary portion 16. A wheel with a rubber wheel is pressed onto the input shaft 33 of the electrical measurement component 32 and disposed in contact with the track 22 for rotational movement along the track 22. The rubber material, or a similar material, sufficiently grips the track 22 in a manner that allows the precise distance traversed by the wheel to result in an electrical signal generated by the electrical measurement component 32 to positively indicates a position of the retractable portion 12 of the steering column assembly 10.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A position detection system for a retractable steering column assembly comprising:
a track having a plurality of teeth extending therealong, the track operatively coupled to a stationary portion of the retractable steering column assembly;
a gear in meshed engagement with the plurality of teeth of the track and moveable therealong; and
an electrical measuring component operatively coupled to the gear to convert motion of the gear into an electrical signal that corresponds to a position of a retractable portion of the retractable steering column assembly, the retractable portion translatable between an extended position and a retracted position, the electrical measuring component operatively coupled to the retractable portion.

2. The position detection system of claim 1, wherein the track is operatively coupled to the stationary portion with mechanical fasteners.

3. The position detection system of claim 1, wherein the stationary portion comprises a lower jacket of the retractable steering column assembly that is in a telescoping relationship with the stationary portion.

4. The position detection system of claim 1, wherein the electrical measuring component comprises a potentiometer.

5. The position detection system of claim 1, wherein the retractable portion is an upper jacket of the retractable steering column housing

6. The position detection system of claim 5, wherein the electrical measuring component is operatively coupled to a split nut receiving a threaded fastener.

7. The position detection system of claim 1, wherein the electrical measuring component is in operative communication with an autonomous driving assist steering system.

8. The position detection system of claim 7, wherein the autonomous driving assist steering system controls translation of the retractable portion between the extended position and the retracted position.

9. A position detection system for a retractable steering column assembly comprising:
a track having a planar surface of a stationary portion of the retractable steering column assembly;
a wheel in contact with the track and moveable therealong; and
an electrical measuring component operatively coupled to the wheel to convert motion of the wheel into an electrical signal that corresponds to a position of a retractable portion of the retractable steering column assembly, the retractable portion translatable between an extended position and a retracted position, the electrical measuring component operatively coupled to the retractable portion.

10. The position detection system of claim 9, wherein the stationary portion comprises a lower jacket of the retractable steering column assembly.

11. The position detection system of claim 9, wherein the electrical measuring component comprises a potentiometer.

12. The position detection system of claim 9, wherein the retractable portion comprises an upper jacket that is in a telescoping relationship with the stationary portion.

13. The position detection system of claim 12, wherein the electrical measuring component is operatively coupled to a split nut receiving a threaded fastener.

14. The position detection system of claim 9, wherein the electrical measuring component is in operative communication with an autonomous driving assist steering system.

15. The position detection system of claim 14, wherein the autonomous driving assist steering system controls translation of the retractable portion between the extended position and the retracted position.

16. The position detection system of claim 9, wherein the wheel is formed of rubber.

17. A retractable steering column assembly for a selectively autonomous vehicle comprising:
a lower jacket;
a column housing moveable between an extended position and a retracted position;
a plurality of teeth fixed to a surface of the lower jacket;
a pinion gear in meshed engagement with the plurality of teeth; and
a potentiometer having an input shaft operatively coupled to the gear, the potentiometer converting motion of the gear into an electrical signal that corresponds to a position of the column housing.

18. The retractable steering column assembly of claim 17, wherein the plurality of teeth are integrally formed with the surface of the lower jacket.

19. The retractable steering column assembly of claim 17, wherein the plurality of teeth is a track coupled to the lower jacket with a plurality of mechanical fasteners.

20. The retractable steering column assembly of claim 17, wherein the potentiometer is in operative communication with an autonomous driving assist steering system that controls translation of the column housing.
